(19) United States
(12) Patent Application Publication
(10) Pub. No.: US 2007/0012260 A1
(43) Pub. Date: Jan. 18, 2007

(54) Remotely activated pet beacon

(75) Inventors: Randal D. Boyd, Knoxville, TN (US); Christopher E. Mainini, Knoxville, TN (US); E. Douglas Grindstaff II, Knoxville, TN (US); William Wallace, Maryville, TN (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/179,159

(22) Filed: Jul. 12, 2005

(51) Int. Cl. A01K 15/02

(52) U.S. Cl. 119/720

(57) ABSTRACT

A remotely activated pet beacon for facilitating the rescue of pets in distress is disclosed. The pet beacon provides a control circuit for controlling the pet beacon's response to events, a communication system for facilitating remote activation of the pet beacon and for interactive, remote communication with a selected entity, a distress indicator for signaling that a pet is in need of assistance, and an actuator for initiating communication with a selected entity using the communication system built into the pet beacon.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of Invention

The present invention pertains to the field of pet rescue. More particularly, the present invention relates to a pet beacon for attracting the attention of a person and allowing that person to communicate with a designated party such as the owner, regarding arrangements for the pet.

2. Description of the Related Art

It is well known that despite the best efforts of pet owners worldwide, pets get lost and hurt. When pets need help, any number of people may actually be near the animal. Many of those may also be in a position to render assistance. Unfortunately, there is normally no way for them to know that the pet needs help. It is also well known that pets often carry tags indicating their owner's name, address, and phone number. In today's world, the increased incidence of identity theft as well as other crimes makes this a security risk. Furthermore, it may be quite inconvenient for a person who is trying to help an animal to take the animal to the owner or even to bring it along while the person is searching for a phone.

Other devices have been developed to attempt to overcome these and similar problems associated with lost pets. Typical of the art are those devices disclosed in the following U.S. patents:

| Patent No. | Inventor(s) | Issue Date |
|---|---|---|
| 5,036,610 | V. K. Fehr | Aug. 6, 1991 |
| 5,762,335 | K. Shimogori | May 19, 1998 |
| 6,003,473 | L. R. Printz | Dec. 21, 1999 |
| 6,329,918 | J. L. Moyer | Dec. 11, 2001 |
| 5,912,921 | K. H. Fulton | Oct. 26, 1999 |
| 5,054,051 | D. G. Hoff | Oct. 01, 1991 |
| 5,454,350 | S. M. Betheil | Oct. 03, 1995 |
| 5,912,956 | R. J. Longo | Jun. 15, 1999 |
| 5,955,953 | M. C. Hanson | Sep. 21, 1999 |
| 6,067,018 | J. M. Skelton | May 23, 2000 |
| 6,568,354 | D. J. Wasserman | May 27, 2003 |
| 6,740,879 | M. Edwards | Apr. 13, 2004 |
| 6,581,073 | R. M. Adler | Jun. 17, 2003 |
| 5,515,033 | R. Matarazzo | May 7, 1996 |

The Fehr ('610) patent discloses a system for identifying a lost pet and locating its owner. The system includes a central clearing house and a pet collar or tag with a telephone number and a unique code number printed on them. Information about the pet and its owner is stored at the central clearing house under the unique number and is retrievable by the finder of the pet.

The Shimogori ('335) patent discloses a talking pet tag with a pre-recorded message. The message is played by the finder of a lost pet by simply depressing a play button. The recording mechanism is shielded by a cover plate. The method of retrieving lost pets using the device is also disclosed. Hanson ('953) and Printz ('473) also disclose devices that allow an audio message to be recorded by the owner and then played by the finder of a lost pet. Similarly, Wasserman ('354) discloses a pet identification tag with an electronic display that displays pet owner identification information when activated by pressing a button on the tag.

The Betheil ('350) patent discloses an electronic dialing attachment adapted to be secured to a pet collar or other band member worn by a pet. The dialing element is programmable to store the telephone number of the owner of the pet and is detachable from the band member. The dialing element is adapted to be positioned near the handset of a telephone, thereby permitting the owner of the pet to be contacted without delay.

Longo ('956) discloses a system and method for anonymously making phone calls. The system includes multiple identification tags, a master control telephone calling card, a computer program, a voice synthesizer and a telephone switch. Each identification tag has visible instructions on how a finder of a pet with an identification tag can make a toll-free telephone call to the owner.

The Skelton ('018) patent discloses a lost pet notification system that includes three elements: a pet collar that automatically activates an alarm once the pet becomes lost, a portable hand held unit that continually monitors the location of the pet, and a base station that automatically transmits a signal to the owner once the portable unit determines that the pet is lost. The pet collar continually receives a polling signal from the portable unit while the pet is within transmission range. In response to each polling signal, the pet collar transmits a reply signal to the portable unit. Once the polling signal can no longer be detected by the pet collar, the pet collar automatically activates an alarm. In addition, the portable unit activates an alarm and also transmits a notification signal to the base station. Once the notification signal is received, the base station automatically places a telephone call to a predetermined telephone number and plays an associated message to alert the pet owner that the pet is lost.

Edwards ('879) discloses an animal collar for locating or tracking animals. The animal collar includes a digital video camera that generates video signals, a global positioning unit for receiving a global positioning signal and a controller in communication with the digital video camera and the global positioning unit. The controller includes a wireless communications link over which it transmits the video signals to a remote source.

Adler ('073) discloses a system that allows a pet owner to upload photographs of a lost pet, as well as other information, including contact information, to a web site. The system then distributes a photo e-mail via the internet to people in the area in which the pet is lost. The system also performs calculations using information about the pet to determine the most appropriate target area for a search.

Matarazzo ('033) discloses a lost pet retrieval collar that receives a coded radio signal and activates a puncturing device to release gas from a pressurized canister to inflate a balloon creating a visual alarm that the pet is lost. The pet collar also contains information necessary to enable a passerby to contact the pet owner.

### BRIEF SUMMARY OF THE INVENTION

A remotely activated pet beacon for facilitating the rescue of pets in distress is disclosed. The pet beacon, which is carried by a pet, provides a control circuit for managing the pet beacon and a communication system for remote activation and interactive, remote communication with a selected entity. When the pet owner determines the pet is in need of help, the owner contacts the pet beacon through the pet beacon's communication system and sends the activation instruction, which is relayed to the control circuit. The control circuit stores contact information provided as part of the instruction and uses a distress indicator to begin continuously signaling that the pet is in need of assistance. The signaling is designed to attract the attention of a person to detain the pet and render assistance. The pet beacon also provides an actuator for a person who is attracted by the signaling and detains the pet to cause the pet beacon's communication system to initiate an interactive, remote communication session using the previously stored contact information. Once the communication session has ended, the pet beacon returns to waiting on a communication request and an activation instruction.

### BRIEF DESCRIPTION OF THE SEVERAL VIEWS OF THE DRAWINGS

The above-mentioned features of the pet beacon will become more clearly understood from the following detailed description of the pet beacon read together with the drawings in which:

FIG. 1 is an illustration of one embodiment of the pet beacon in use;

FIG. 2 is a block diagram of the pet beacon;

FIG. 3 is an illustration of one embodiment of the pet beacon on a pet;

FIG. 4 is a state diagram of one embodiment of the pet beacon.

### DETAILED DESCRIPTION OF THE INVENTION

A remotely activated pet beacon adapted for interactive, remote communication with a selected entity is disclosed and is illustrated generally at 10 in the figures. The pet beacon 10 is carried by a pet and facilitates the rescue of a pet when lost.

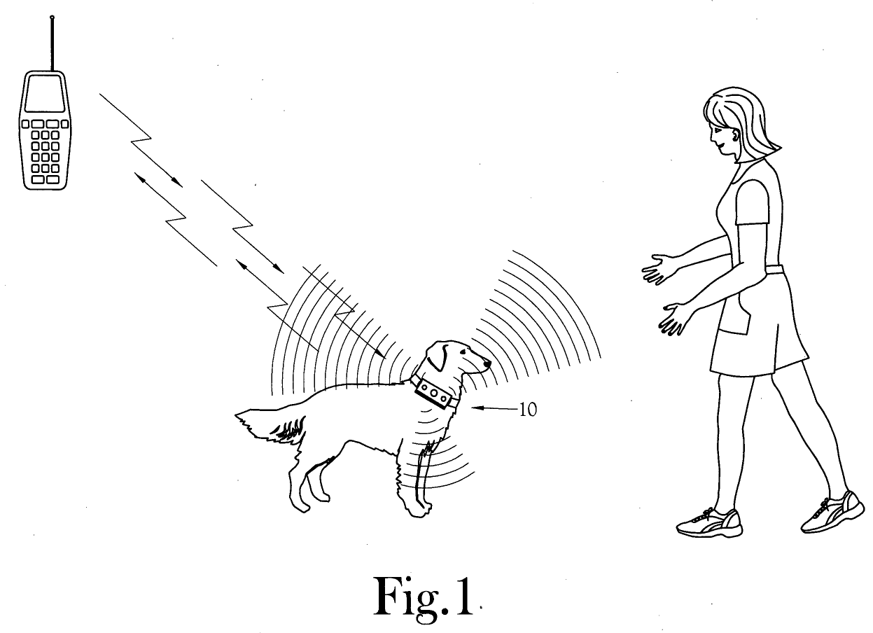

FIG. 1 illustrates the pet beacon 10 in use. When the pet owner realizes that the pet is missing, the owner contacts the pet beacon 10 and activates it by sending an activation instruction and providing information for establishing contact with a selected entity, which is often the owner. Once activated, the pet beacon 10 begins signaling that the pet is in need of assistance. Signaling of the pet beacon 10 is designed to attract the attention of a person who then detains the pet and initiates a communication with the selected entity through the pet beacon 10.

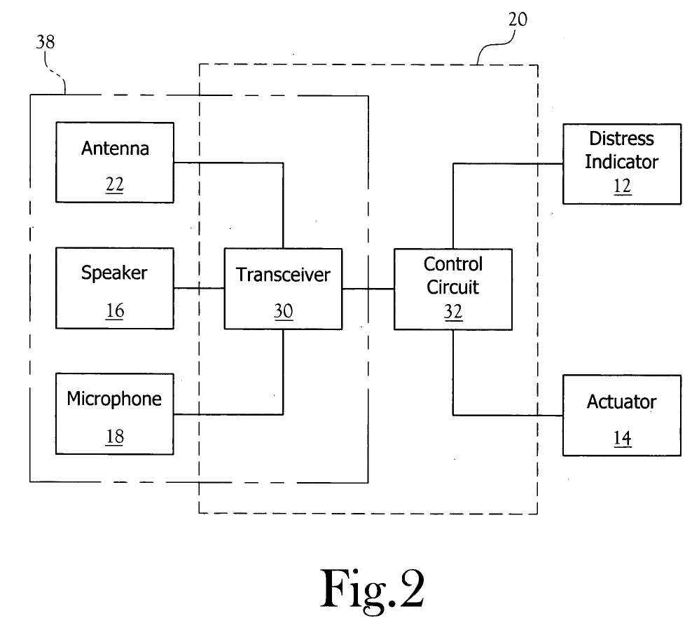

FIG. 2 is a block diagram of the pet beacon 10. The pet beacon 10 includes a housing 20, which in the preferred embodiment is adapted to allow sound waves to enter and exit the housing 20. The housing 20 carries electrical circuitry and other devices inside, where protection is provided from substances and events that affect the operation of the pet beacon 10, including but not limited to, weather and shock. The housing 20 is also adapted so that devices can be securely attached to the outside of the housing 20.

As shown in FIG. 2, the housing 20 contains a control circuit 32 that provides the function of managing data and controlling the pet beacon's 10 response to events. The control circuit 32 in the preferred embodiment includes non-volatile memory, RAM, a timer, a serial interface, and a CPU. In one embodiment, the function of stopping the pet beacon 10 from signaling that the pet is in distress, which may be irritating once someone begins to help, is also performed by the control circuit 32. It will be recognized by those skilled in the art that sub-systems of the control circuit 32 may be integral to the control circuit 32, provided as separate components, or emulated in software without departing from the scope and spirit of the current invention or altering the result.

The control circuit 32 of FIG. 2 is adapted to respond to a notice of a remote communication request. The control circuit 32 is also adapted to accept and store information provided by the originator of the remote communication request and to decide whether the information contains a valid activation instruction. If the information contains valid contact information for a selected entity as well as a valid activation instruction, the control circuit 32 activates the pet beacon 10 in order to attract the attention of a person to help the pet.

The control circuit 32 is shown connected to a communication system 38 in FIG. 2. It will be recognized by those skilled in the art that the communication system 38 and the control circuit 32 may be integrated or separate and that the connection between the control circuit 32 and the communication system 38 may utilize different circuitry or may communicate using any protocol without departing from the scope and spirit of the current invention or altering the result.

The communication system 38 provides for remote activation and interactive, remote communication with a selected entity. In order to provide remote activation, the communication system 38 is adapted to notify the control circuit 32 of an incoming remote communication request, to respond to a command to accept the remote communication request, and to provide information from the originator of the remote communication.

In order to provide interactive, remote communication with a selected entity, the communication system 38 is also adapted to respond to a command to initiate an interactive, remote communication session with the entity whose contact information is previously provided. The communication system 38 includes a transceiver 30 as shown in FIG. 2. The transceiver 30 is adapted to encode data, such as a person's voice, for transmission and to extract data from a signal after it is received. It will be recognized by those skilled in the art that the functions provided by the transceiver 30 may also be provided as a separate transmitter in combination with a separate receiver without departing from the scope and spirit of the current invention or altering the result.

The transceiver 30 is connected to an antenna 22 in FIG. 2. The antenna 22 is adapted to convert electromagnetic waves into electrical signals. Electromagnetic waves are transmitted whenever the pet beacon 10 receives a remote communication such as an activation instruction. The antenna 22 is also adapted to receive electrical signals, the receipt of which causes the electrical signals to be broadcast by the antenna 22 as electromagnetic waves.

The transceiver 30 is also connected to a speaker 16 as is illustrated in FIG. 2. The speaker 16 converts electrical signals into sound waves so that the selected entity's voice, which is received as electromagnetic waves and converted to electrical signals, can be heard by the rescuer who has initiated the communication. The speaker 16 is physically positioned so that sound waves radiate outward from the pet beacon 10.

The transceiver 30 is further connected to a microphone 18 as shown in FIG. 2. The microphone 18 converts sound waves into electrical signals. Sound waves are generated by a rescuer's voice when the rescuer is using the pet beacon 10 to communicate with the owner. The microphone 18 of FIG. 2 is positioned on or in the pet beacon 10 so that sound waves generated by the rescuer's voice are not blocked or muffled and can engage the microphone 18 without interference.

The control circuit 32 illustrated in FIG. 2 is connected to a distress indicator 12 that provides the function of signaling that the pet is lost or in distress. When the pet beacon 10 is activated, the distress indicator 12 attracts the attention of a person by predetermined signaling.

It will be recognized by those skilled in the art that any device capable of attracting a person's attention may be used as a distress indicator without departing from the scope and spirit of the current invention or altering the result. Such devices include light emitting diodes (LEDs), 7-segment displays, liquid crystal displays (LCDs), continuous grain silicon panels, strobe-lights, and neon lights, to name just a few that produce a visible effect. Audio effects are also possible. Even Bluetooth technology, which allows messages to be sent to other Bluetooth enabled devices in the immediate vicinity, or one of the wireless Internet connection protocols such as IEEE 802.11b, could be used.

The control circuit 32 is also connected to an actuator 14, which provides the function of initiating an interactive, remote communication session with a selected entity so that arrangements for care of the pet can be made. The actuator 14 generates an electrical signal when engaged. In response to the signal from the actuator 14, the pet beacon 10 tries to establish an interactive, remote communication session using the previously provided contact information for the selected entity. In one embodiment, the actuator 14 provides the function of stopping the pet beacon 10 from signaling that the pet is in distress. The signaling can be stopped once a rescuer contacts the previously designated entity since the signaling is no longer necessary and it is likely that the signaling will irritate a rescuer who is caring for the pet temporarily. It will be recognized by those skilled in the art that the actuator 14 is a switch that either closes or opens an electrical circuit to generate a signal to the control circuit 32 and that any switch can be used without departing from the scope and spirit of the current invention or altering the result. The pet beacon 10 returns to its initial state when an interactive communication session has been terminated.

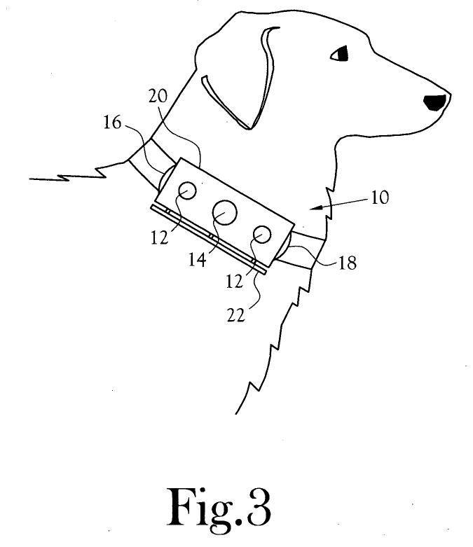

FIG. 3 is an illustration of one embodiment of the pet beacon 10 on a pet. The housing 20 in this particular embodiment is rectangular. The antenna 22 is a traditional design and is fastened to the bottom of the housing 20 on the outside. The speaker 16 in FIG. 3 is mounted at one end of the long side of the housing 20 under a thin membrane that protects the speaker 16 from the elements while still allowing the generated sound waves to radiate outward with minimal interference. The microphone 18 is mounted under the same type thin membrane at the opposite end of the pet beacon 10. Two light emitting diodes are mounted on the outside of the front surface, one toward either end. The LEDs act as the distress indicator 12 in the illustrated embodiment. The actuator 14 of FIG. 3 is a normally open, pushbutton.

The transceiver 30 in the embodiment of FIG. 3 is adapted to utilize existing cellular telephone technology and infrastructure. This embodiment, therefore, has a cellular telephone number and can be activated by calling the pet beacon 10 and pressing a coded sequence on the caller's telephone keypad. When activated, the pet beacon 10 begins to cycle the power to the two LEDs 12 thus creating a flashing effect by turning the two LEDs 12 on and off. The flashing effect is designed to attract the attention of a potential rescuer. Once a rescuer sees the two LEDs 12 flashing and subsequently detains the animal, the rescuer can initiate a cellular telephone call to a cell phone number that was provided with the activation instruction by depressing the pushbutton 14. The rescuer can then speak directly to whomever the pet beacon 10 calls. The pet beacon 10 uses the microphone 18, the transceiver 30, and the antenna 22 to accept and transmit the rescuer's voice. The antenna 22, the transceiver 30, and the speaker 16 are used for receiving and providing the voice of the person the pet beacon 10 calls. When the cellular telephone call initiated by the rescuer ends, the pet beacon 10 returns to its initial state of waiting for a cellular telephone call and activation instruction.

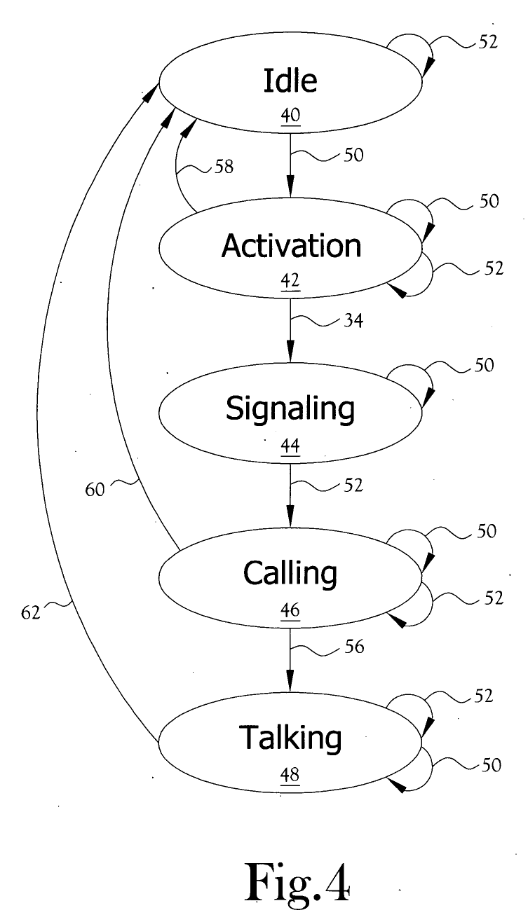

FIG. 4 shows one embodiment of the pet beacon 10 that has five states and eight distinct events that cause transitions from one state to another. The states in this embodiment as well as the events that trigger transitions from one state to the next are illustrated in FIG. 4. Other events that occur in each state are ignored.

The first state is an Idle state 40. In the Idle state 40 the pet beacon 10 is waiting on instructions. The Idle state 40 is the state that the pet beacon 10 enters after power is applied, after a failure to establish a communication session and after a communication is terminated. The transition from the Idle state 40 to an Activation state 42 is triggered by a notification that a request for communication 50 has been received. If an event other than the notification that a request for communication 50 is received while the pet beacon 10 is in the Idle state 40, the event will be ignored.

When the pet beacon 10 is in the Activation state 42, a remotely initiated communication session is being established and instructions are being received and evaluated. While in the Activation state 42, the pet beacon 10 will not allow another communication session to be established. An activation event 54 occurs when the pet beacon 40 is instructed to become active and an entity to be contacted is identified during the remotely initiated communication session. When the activation event 54 occurs, the pet beacon 10 transitions to a Signaling state 44, otherwise a failed activation 58 returns the pet beacon 10 to the Idle state 40. The Activation state 42 is primarily for the support of remote communication sessions that require the pet beacon 10 to wait for a response from the remote entity, thus creating a window of opportunity for other events to occur and for the current communication session to end without the activation event 54 thus generating the failed activation 58 illustrated.

When the pet beacon 10 enters the Signaling state 44, the pet beacon begins signaling that the pet is in need of assistance. In the Signaling state 44 the pet beacon 10 is waiting for a person to detain the animal and to initiate a call request 52. A call request 52 is a request from the person who detained the pet for the pet beacon 10 to initiate an interactive, remote communication session with the entity identified in the previous Activation state 42. The pet beacon 10 does not allow the establishment of a communication session for which the pet beacon 10 is not the originator while in the Signaling state 44.

When the pet beacon 10 receives the call request 52, the pet beacon 10 enters a Calling state. The pet beacon 10 then attempts to establish an interactive, remote communication session with the entity identified in the previous Activation state 42. If the interactive, remote communication session 56 is not successfully established, a failed connection event 60 causes the pet beacon 10 to return to the Idle state 40. The pet beacon 10 does not allow a communication session in which the pet beacon 10 is not the originator to be established nor does it respond to other call requests in the Calling state 46.

If the pet beacon 10 is successful in establishing the interactive, remote communication session 56 in the Calling state 46, the pet beacon 10 enters a Talking state 48, which allows interactive communication with the previously designated entity. In the Talking state 48, the pet beacon 10 only responds to a termination event 62, which is a notification that the communication session has been terminated. Upon receiving the termination event 62, the pet beacon 10 re-enters the Idle state 40.

From the foregoing description, it will be recognized by those skilled in the art that a remotely activated pet beacon 10 for facilitating the rescue of pets in distress has been provided. The pet beacon 10 provides a control circuit for controlling the pet beacon 10, a communication system 38 for remote activation and for interactive, remote communication with a selected entity, a distress indicator 12 for signaling that a pet is in need of assistance, and an actuator 14 for initiating communication with the selected entity using the communications system 38 built into the pet beacon 10.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, We claim:

1. A remotely activated pet beacon for facilitating the rescue of a pet in distress, said pet beacon comprising:
a control circuit adapted to manage data and control said pet beacon's response to events;
a communication system in communication with said control circuit, said communication system adapted to signal said control circuit when a request for communication is received, said communication system adapted to accept commands from said control circuit and to supply data to said control circuit, said communication system further adapted to establish interactive, remote communication sessions with a selected entity, said communication system adapted to signal said control circuit when an interactive, remote communication session is terminated;
a distress indicator in communication with said control circuit such that said control circuit controls said distress indicator whereby potential rescuers can be selectively signaled that the pet is in distress;
an actuator in communication with said control circuit, said actuator adapted to generate a signal as input to said control circuit when said actuator is engaged whereby a rescuer initiates an interactive, remote communication session with the selected entity.

2. The pet beacon of claim 1 wherein said communication system further comprises:
a transceiver;
an antenna for facilitating remote activation and interactive, remote communication with a designated entity, said antenna in communication with said transceiver, said antenna adapted to convert electromagnetic signals received directly by said antenna to electrical signals as input for said transceiver and said antenna adapted to convert electrical signals from said transceiver to electromagnetic signals and to broadcast the electromagnetic signals;
a speaker in communication with said transceiver, said speaker adapted to convert incoming electrical signals into sound waves whereby audio originating with a selected entity is provided for the rescuer; and
a microphone in communication with said transceiver, said microphone adapted to convert incoming sound waves into electrical signals as input to said transceiver whereby audio input from the rescuer is transported through said transceiver to said antenna for conversion to electromagnetic signals and subsequent broadcast as part of the remote, interactive communication provided by the pet beacon so that the rescuer and the previously designated entity can make arrangements regarding the pet.

3. The pet beacon of claim 2 wherein said distress indicator comprises at least one light emitting diode (LED).

4. The pet beacon of claim 3 wherein said actuator comprises a normally open pushbutton.

5. The pet beacon of claim 1 wherein said distress indicator comprises at least one light emitting diode (LED).

6. The pet beacon of claim 5 wherein said actuator comprises a normally open pushbutton.

7. The pet beacon of claim 1 wherein said actuator comprises a normally open pushbutton.

8. A remotely activated pet beacon for facilitating the rescue of pets in distress, said pet beacon comprising:
a means for controlling said pet beacon's response to events;
a means for remotely activating said pet beacon;
a means for signaling that a pet is in distress;
a means for establishing and conducting an interactive, remote communication session with a selected entity.
a means for initiating said interactive, remote communication session.

9. The pet beacon of claim 8 further comprising a means for stopping said means for signaling that a pet is in distress from so signaling;

10. A method in a control circuit for controlling a pet beacon, the method comprising the steps of:
Initializing control circuit resources, said control circuit resources including RAM, a timer, a serial port, and an interrupt controller;
initializing input devices, output devices, and system variables, said input devices including a transceiver and an actuator, said output devices including said transceiver and a distress indicator, said system variables including a system state variable;
waiting on and receiving an activation instruction and contact information from said transceiver;
signaling that the pet needs assistance in response to said activation instruction and said contact information using said distress indicator;
waiting on and receiving a call request from said actuator;
instructing said transceiver to establish an interactive, remote communication session and providing contact information to said transceiver in response to said call request; and
waiting on and receiving notification from said transceiver that said interactive, remote communication session has ended.
